(19) United States
(12) Patent Application Publication
(10) Pub. No.: US 2015/0015789 A1
(43) Pub. Date: Jan. 15, 2015

(54) METHOD AND DEVICE FOR RENDERING SELECTED PORTIONS OF VIDEO IN HIGH RESOLUTION

(71) Applicant: Samsung Electronics Co., Ltd., Suwon-si (KR)

(72) Inventors: Ravindra GUNTUR, Mysore Karnataka (IN); Mahesh Krishnananda PRABHU, Bangalore (IN); Vidhu Bennie THOLATH, Bangalore (IN); Vishwanath Madapura GANGARAJU, Bangalore (IN)

(21) Appl. No.: 14/324,747

(22) Filed: Jul. 7, 2014

(30) Foreign Application Priority Data
Jul. 9, 2013 (IN) 3069/CHE/2013

(51) Int. Cl. H04N 5/262; H04N 5/44

(52) U.S. Cl. CPC H04N 5/2628; H04N 5/4401
USPC 348/581

(57) ABSTRACT

A method and an electronic device for rendering a selected portion in a video displayed in a higher resolution in a pull-based streaming are provided. The electronic device, when a user selects a portion of the video at a first resolution, identifies display coordinates associated with the video played at the first resolution. The identified display coordinates associated with the video are scaled to a second resolution of a frame of the video. Once the display coordinates are scaled in accordance to the second resolution of the video, the electronic device identifies at least one tile associated with the selected portion in the second resolution. After identifying the tile associated with the selected portion, the electronic device receives a video stream of the selected portion of the video and renders the selected portion on the electronic device.

### CROSS-REFERENCE TO RELATED APPLICATION(S)

This application claims the benefit under 35 U.S.C. §119(a) of an Indian Provisional Patent Application filed on Jul. 9, 2013 in the Indian Patent Office and assigned Serial No. 3069/CHE/2013, and of an Indian Patent Application filed on Jan. 10, 2014 in the Indian Patent Office and assigned Serial No. 3069/CHE/2013 the entire disclosure of each of which is hereby incorporated by reference.

### TECHNICAL FIELD

The present disclosure relates to selecting a region of interest in a video. More particularly, the present disclosure relates to displaying the selected region of interest in a higher resolution in pull-based streaming.

### BACKGROUND

With the development of Dynamic Adaptive Streaming over HTTP (DASH), and an increasing ability of cameras capturing high definition video, new demands are being placed on network bandwidth and processing capability.

High resolution video, such as 4096×2304, increases the network bandwidth requirement significantly. Currently, all the electronic devices do not support this higher resolution video. In an electronic device, a user generally watches a video at a lower resolution due to bandwidth restrictions and display resolution limitations. When the user selects a portion of the video for a zoom operation, the zoomed-in portion may appear blurred.

In the related art, a user will be able to experience such high quality zoom only at the expense of high bandwidth consumption. For example, a video may have a 4096×2304 resolution, whereas most current electronic devices have 1080p resolution. Accordingly, if the user is streaming the 4096×2304 resolution video, then the user will only receive a 1080p experience. Once the user performs a zoom on the video rendered at 1080p, the video quality further deteriorates.

In the related art, the decoder of the electronic device stores the high resolution decoded frame buffer (for example of the size 4096×2304), and then crops the user selected video portion from this high quality decoded buffer to avoid video quality deterioration. This demands video decoding of the entire high resolution frame (in this example 4096×2304) by the device, irrespective of whether user is interested to view full portion of the video. In case of zoom, the user is viewing only selected portion, and the other portions are not rendered, though decoded. This results in wastage of computational resources and CPU power in the device.

In the related art, when a user selects an interested portion, dynamically a server creates and re-encodes tiles. This increases the server CPU utilization. Whenever, a user selects a portion in a video, a device rendering a video will request the server to provide the tile associated with the selected portion. This increases computation in the server since server needs to create tiles and re-encode the tile and deliver to the device for rendering.

Although the related art described above has been largely successful in rendering the selected portion in the video and viewing the selected portion in a better resolution, there are several challenges with respect to device resolution, increased bandwidth consumption, increased computation load, increased storage requirement on the electronic device and ability to seamlessly share/transfer user selected portion of video to another display device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and device allowing user interaction on multimedia content at a highest resolution in pull-based streaming.

Another aspect of the present disclosure is to provide a method and device to allow user to zoom and pan multimedia content by consuming lesser bandwidth.

In accordance with an aspect of the present disclosure, a method for rendering a selected portion in a video displayed in a device is provided. The method includes obtaining the selected portion in the video, wherein the video is played in a first resolution. Further, the method includes identifying at least one tile associated with the obtained selected portion in a second resolution. Furthermore, the method includes rendering the selected portion in the second resolution by receiving the at least one identified tile.

In accordance with another aspect of the present disclosure, a method for encoding at least one tile in a video is provided. The method includes segmenting at least one frame of the video into at least one tile, wherein the at least one frame is associated with at least one resolution. The method further includes encoding the at least one tile and assigning a reference to the encoded tile.

In accordance with another aspect of the present disclosure a device for rendering a selected portion in a video is provided. The device includes an integrated circuit including at least one processor and includes at least one memory. The memory stores a computer program code. When executed, the computer program code causes the at least one processor of the device to obtain the selected portion in the video, wherein the video is played in a first resolution. Further, when executed, the computer program code causes the at least one processor of the device to identify at least one tile associated with the obtained selected portion in a second resolution and to render the selected portion in the second resolution by receiving the at least one identified tile.

These and other aspects of the disclosure herein will be better appreciated and understood when considered in conjunction with the following description and the accompanying drawings. It should be understood, however, that the following descriptions are given by way of illustration and not of limitation. Many changes and modifications may be made within the scope of the present disclosure without departing from the spirit thereof, and the present disclosure includes all such modifications.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 depicts a high level architecture of a system according to an embodiment of the present disclosure;

FIG. 2 depicts a block diagram with components used for creating tile encodings in a video encoding process according to an embodiment of the present disclosure;

FIGS. 3A, 3B, and 3C depict illustrations of a video frame partitioned into tiles according to various embodiments of the present disclosure;

FIG. 4 depicts an illustration of scaling of display coordinates in different resolution levels according to an embodiment of the present disclosure;

FIG. 5 is a flowchart describing a method of encoding a video according to an embodiment of the present disclosure;

FIG. 6 is a flowchart describing a method of rendering a selected portion in a second resolution according to an embodiment of the present disclosure;

FIG. 7 is a flowchart describing a method of identifying user interaction with a video according to an embodiment of the present disclosure;

FIG. 8 is a flowchart describing a method of processing a zoom-in interaction with a video at a device according to an embodiment of the present disclosure;

FIG. 9 is a flowchart describing an operation of processing a zoom-out interaction with a video at a device according to an embodiment of the present disclosure;

FIG. 10 is a flowchart describing an operation of processing a pan interaction with a video at a device according to an embodiment of the present disclosure;

FIG. 11 is an example illustration of a multi-view video from multiple individual cameras according to an embodiment of the present disclosure;

FIG. 12 is a flowchart describing an operation of processing a change in camera views at a device according to an embodiment of the present disclosure; and

FIG. 13 illustrates a computing environment for rendering a selected portion of a video according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Player: A player is used to play the video file received at electronic device. The player may be a standalone player or a plug in case of a web browser. The player decodes the received file and renders it to the user.

Portion of the video: The term portion of the video refers to any arbitrary region/section/object of user's interest present in a video. A user can select a portion of video and interact simultaneously. The user interaction on a portion of the video defines the portion of the video selected by user.

Throughout the document the term device and electronic device have been used interchangeably.

The term portion of the video, selected portion and Region of Interest (ROI) have been used interchangeably.

The term level 1, resolution level 1, first resolution and transition level 1 have been used interchangeably.

The term level 2, resolution level 2, second resolution and transition level 2 have been used interchangeably.

The term descriptor file, file and Media Descriptor File (MDF) have been used interchangeably.

In an embodiment, each level of the frame corresponds to a resolution of the video frame of the video.

The term target device refers to any electronic device capable of receiving a file shared from another electronic device.

Examples of electronic device can include, but are not limited to, mobile phone, tablet, laptop, display device, Personal Digital Assistance (PDA), or the like.

In an embodiment, a user can interact with a selected portion of the video by zoom, pan, tilt and the like.

Pull-based streaming: A server sends a file containing the tile information to the media player. Whenever the user interacts in a selected portion, then the media player using the file identifies the tile corresponding to the selected portion and sends request to the server to obtain the tile.

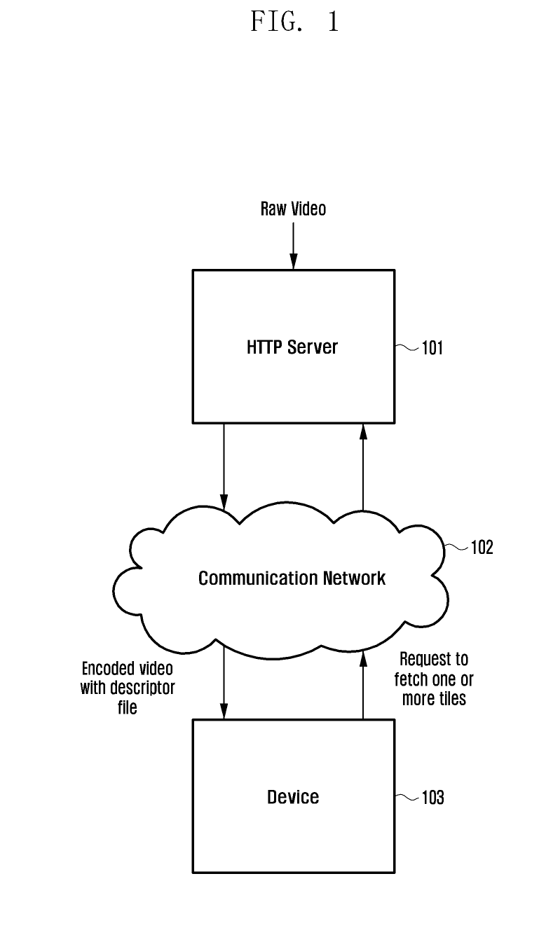

FIGS. 1 through 13, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

The various embodiments herein provide a method and system for rendering a selected portion in a video displayed in an electronic device. When a user selects a portion of the video at a first resolution, the electronic device identifies display coordinates associated with the video played at the first resolution. The identified display coordinates associated with the video is scaled to a second resolution of a frame of the video. Once the display coordinates are scaled in accordance to the second resolution of the video, the device is configured to identify at least one tile associated with the selected portion in the second resolution. After identifying the tile associated with the selected portion, the device receives the selected portion of the video and renders the selected portion on the electronic device.

Referring now to the drawings, and more particularly to FIGS. 1 through 13, where similar reference characters denote corresponding features consistently throughout FIGS. 1 through 13, there are shown various embodiments.

FIG. 1 depicts a high level architecture of a system according to an embodiment of the present disclosure.

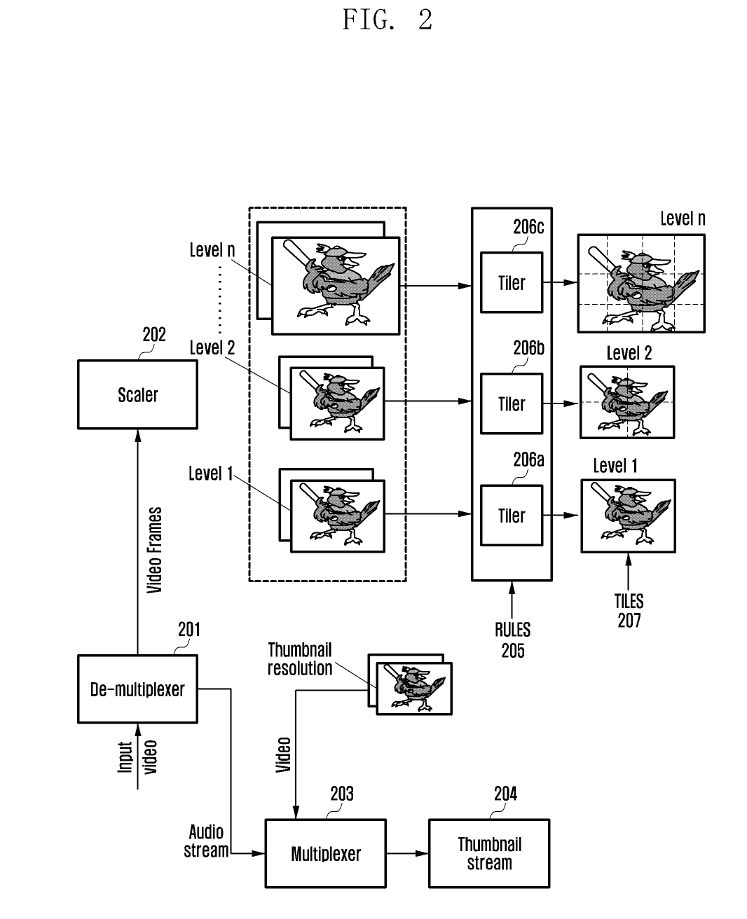

Referring to FIG. 1, a HTTP server 101, a communication network 102 and a device 103 are illustrated. The HTTP server 101 can be configured to receive a raw video and performs a video encoding using an automatic tiled video stream generator. A request to fetch one or more tiles is sent from the device 103 and an encoded video along with a descriptor file is sent to the device 103. FIG. 2 described below explains the process of encoding the raw video and information sent in the descriptor file. The encoded video can be streamed at the device 103 using a HTTP based dynamic adaptive streaming over HTTP framework. On receiving the encoded video, a player on the device 103 plays the video at a resolution supported by the device 103. The encoded video contains a thumbnail video for identifying the display coordinates of a portion selected by the user. The user can select a portion of the video to be rendered at a second resolution. A display coordinate is identified by the device 103 corresponding to the selected portion in the video. The identified display coordinates in the first resolution of the video are scaled to a video coordinates in a second resolution of the video. Based on the video coordinates identified in the second resolution, one or more tile associated with the portion of interest is identified. In an embodiment, the HTTP server 101 can be configured to create the tile and encode the tile in the video. In an embodiment, the server can be configured to segment one or more frames of the video into one or more tiles. The one or more frames are associated with one or more resolutions. Further the HTTP server 101 can be configured to encode one or more tiles and assign a reference to the one or more encoded tiles. In an embodiment, the reference can be a Uniform Resource Locator (URL). This reference is used to fetch the tile associated with the selected portion. The method supports spatio-angular-temporal region-of-interest. The method changes the display coordinates of the selected portion in the video to the video coordinates.

FIG. 2 depicts a block diagram with components used for creating tile encodings in a video encoding process according to an embodiment of the present disclosure.

Referring to FIG. 2, an automatic tiled video stream generator is used by the HTTP server 101 for transcoding the video stream into plurality of tile encodings. An input video of high definition or ultra-high definition is used for encoding. The input video can be a raw video or an encoded video. A de-multiplexer 201 can be configured to segment the input video into a plurality of video frames in short segments of time. A scaler 202 can be configured to create multiple resolutions for each video frame. Multiple resolution representation created for each video frame is shown in FIG. 2. The scaler 202 can be configured to scale down the input video to “n” levels smaller than the input video. For example, an input video with resolution of 4096×2304 can be scaled down to 4 different resolution levels such as 1920×1080, 1280×720, 640×360 and 160×120. Each frame segmented from the video is scaled down to different resolution levels. The level 1, level 2 and level n shown in FIG. 2 correspond to resolution level 1, resolution level 2, and resolution level n (the highest resolution level). The resolution level n corresponds to the highest resolution of the video frame and resolution level 1 corresponds to the lowest resolution of the video. The highest resolution level and the lowest resolution level of the video frame can be considered as configuration parameters to the scaler 202. The scaler 202 can be configured to create a thumbnail resolution corresponding to a lowest/smallest resolution (for example—160×120). In an embodiment, the thumbnail resolution can be multiplexed using an audio stream separated from the input video using a multiplexer 203 to form a thumbnail stream 204. The thumbnail stream 204 appears as a thumbnail video when the video is played on the device 103.

Tilers 206a, 206b and 206c can be configured to decompose each frame into a grid of tiles. Rules 205 related to the configuration of the tiles are given as an input to tiler 206a, tiler 206b and tiler 206c. As shown in FIG. 2, each tiler is associated with a resolution of different levels. Heuristically generated rules and computationally generated rules are used to determine the tile dimensions and tile coordinates in a multi-resolution representation of the video frames. Level 1, level 2 and Level n in FIG. 2 show multiple resolutions of the video frame.

Each created tile (e.g., tiles 207) may be of a fixed or variable dimension. In an embodiment, the created tiles may be of arbitrary dimension, may overlap and can be arranged sequentially in the video frame. For example, if the lowest resolution of the video is of size 640×360, then each tile can be of size 640×360. The first resolution level of the video frame can have only one tile of size 640×360. The second resolution level of the video frame can have four tiles of 640×360 at coordinates (0, 0), (0, and 640), (360, 0) and (360, 640). Each tile is encoded as a video stream and a descriptor file is generated by the tiler for each tile. This process of generating tiles can be repeated for video streams from each camera (each camera may provide a different input video). FIG. 2 shows tiles created for each resolution of the video frame. At the first resolution level of the video frame, only one tile is present for the entire frame. At the second resolution level four tiles are present and at resolution level ‘n’ 12 tiles are present.

In an embodiment, the descriptor file contains information related to resolution level, segment number of the video frame, camera view of the input video, file name of the tile segments and a reference associated with each tile. Each tile created by the automatic tiled video stream generator is associated with resolution level of the video, camera angle view with which the video was captured, a segment number and the like. Each tile is associated with a reference (for example: URL). A union of the descriptor files created for each tile is to generate a single descriptor file for the entire video. This descriptor file can be a MDF. The media descriptor file contains a list of tiles at each resolution level and the corresponding reference for an associated video stream.

The MDF file associated with a video can include information related to the type of video file, the camera view of the video, the segment number of each frame, a reference associated with the video, and the resolution of the video sent to the device 103, transitional information and the like. The transitional information includes the frame width and frame height for each transitional level (resolution level), the tile list associated with each transitional level and the reference associated with each tile. The coordinates of each tile is also present in the MDF.

In an embodiment, the MDF file associated with an encoded tile may be encrypted at the HTTP server 101.

In an embodiment, the MDF file includes multi-view camera angle.

In an embodiment, the tile from higher resolution (second resolution) has a bigger dimension than the tile from a lower resolution (first resolution).

In an embodiment, the tile from a higher resolution (second resolution) level of the frame is the same as the dimension of lower resolution (first resolution).

Consider an example, when a video and an associated descriptor file are received at a device 103. A player in the device 103 can be configured to decode the video and render a video stream and the audio from the thumbnail stream. When the user is watching the streamed video using the player and the user selects a portion of the video being streamed at a first resolution. The electronic device can be configured to identify display coordinates associated with the video played at the first resolution. The identified display coordinates associated with the video being streamed at the first resolution are scaled to the second resolution of the video frame of the video. Once the display coordinates are scaled in accordance to the second resolution of the video, the device 103 can be configured to identify the frame of the video where the user has selected the portion and to identify one or more tiles associated with the selected portion in the second resolution. After identifying one or more tiles associated with the selected portion, the device 103 can be configured to identify the reference associated with the identified tile from the descriptor file of the tile. The reference provides a link to a video stream associated with the tile in second resolution. In an embodiment, the device 103 can be configured to send one or more URL requests to the HTTP server 101 for the video associated with the one or more identified tiles. Once the device 103 receives the one or more tiles renders the video stream associated with the one or more tiles. The user can view the selected portion of the video with higher resolution and better clarity.

In an embodiment, the device 103 may be configured to pre-fetch future tiles associated with the selected portion in future frames of the video in a frame buffer. An object tracking algorithm can be configured to translate the selected portion of the video frame into the thumbnail stream. The device 103 can be configured to track the motion of an object in the selected portion of the thumbnail stream and identify future positions of the object in the thumbnail stream. The device 103 translates the identified future positions of the object to the current resolution level of the video. The device 103 can pre-fetch future tiles associated with the selected portion of the video. The user need not manually select the portion in future frames of the video.

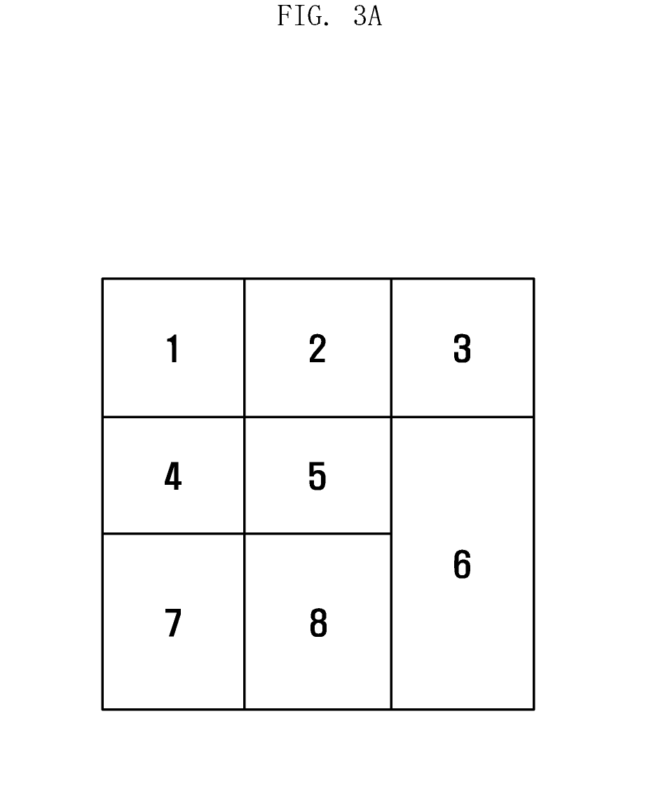

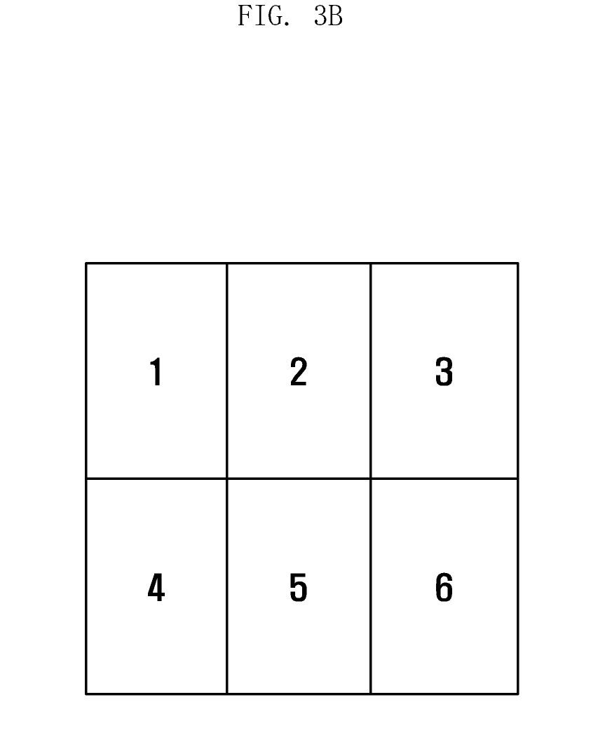

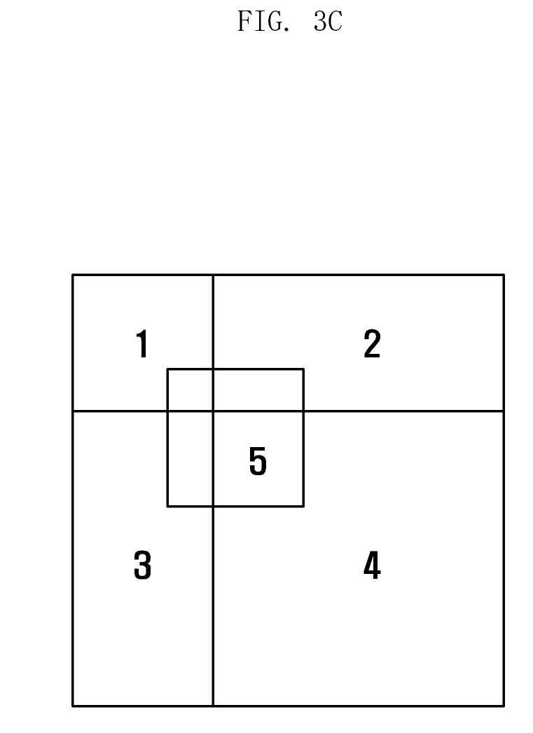

FIGS. 3A to 3C depict illustrations of a video frame partitioned into tiles, according to various embodiments of the present disclosure.

Referring to FIG. 3A, the video frame is divided into eight tiles (e.g., tiles 1 to 8). The tile numbered 6 has a bigger dimension than the rest.

In an embodiment, the dimension of the tile can be based on an object present in the video frame. For example, the tile 6 may include portion of the video which may be of interest to a user. FIG. 3B shows the video frame distributed into 6 tiles (e.g., tiles 1 to 6) of equal dimensions. FIG. 3C shows the video frame divided into 5 tiles (e.g., tiles 1 to 5) and the dimension of each tile is different. The tile 5 is an overlapping tile, covering a region of the video frame shared by all the tiles.

In an embodiment, when user selects a portion in the video and the tile associated with the selected portion is displayed to the user.

In an embodiment, the reference associated with the tile can be inserted to any other video. For example, based on the frequently selected portion in the video, the tile associated with the selected portion can be included in any other video as an advertisement.

In an embodiment, the descriptor file associated with the tile and the reference of the tile is shared with any other target device by the device 103.

The sharing of tiles can allow users to share only a selected portion of the video. Consider an example of a 1 hour classroom video, where a subject matter is being discussed. The video may have a mathematical calculation written on a white board describing the subject matter. The users selected portion may include a mathematical calculation shown in the white board. On selecting and zooming in the user can see the mathematical calculation at a higher resolution. The tile associated with mathematical calculation region of the white board at higher resolution can be shared by the user. The sharing of tiles may help the content provider to identify hot regions (portion selected, viewed and shared of the video) of the video. For example, frequently accessed tiles can indicate that users are interested in a specific portion of the video associated with a specific tile.

In an embodiment, dynamic references can be created for dynamic insertion of content. For example, advertisements may be encoded as a tile and placed in the video when the video is streamed at the electronic device. The advertisement may be changed dynamically based on user preferences and popularity of advertisement. The position of the advertisement in the video frame can also be controlled by the HTTP server 101.

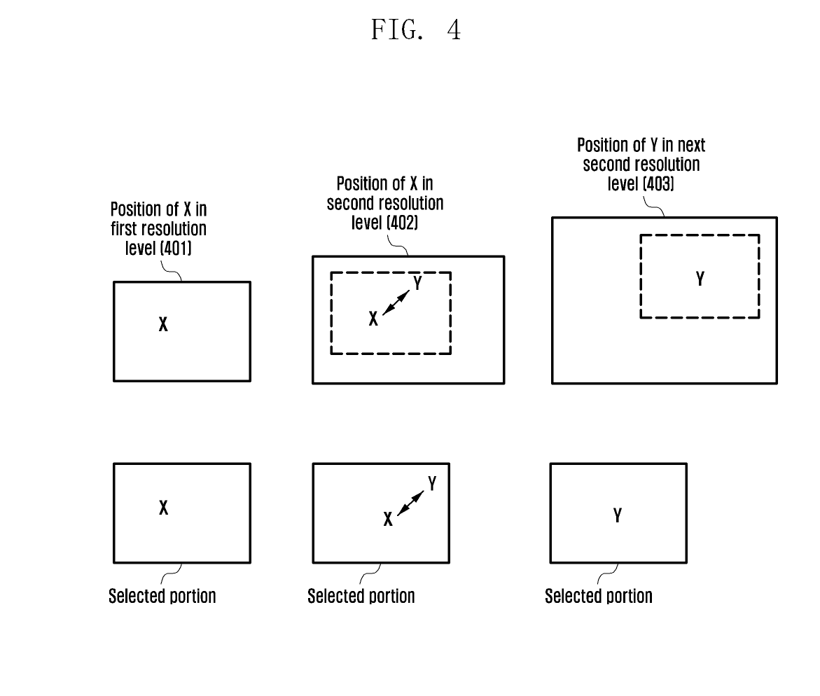

FIG. 4 depicts an illustration of scaling of display coordinates in different resolution levels according to an embodiment of the present disclosure.

Referring to FIG. 4, the user can interact with a portion of the video while selecting a portion of the video. The user can zoom, pan a portion of the video. The user can interact with portion of the video by zoom and pan. The device 103 can be configured to detect the user interaction and identify display coordinates of the selected region during the user interaction.

In an embodiment, the user can select a region of interest in the video and then interact (zoom/pan/tilt) with the video.

Initially the user views the video at a first (lowest) resolution. Position of X in first resolution level is represented in 401. The user selects a region ‘X’ 401 to zoom in. This ‘X’ is the same in the video resolution space. The user zooms into a region around X in the second resolution (next higher resolution level). The Position of X in second resolution level is represented as 402. The dimensions of the dotted rectangle in the second resolution are of the same dimensions as the first resolution frame. Then user zooms-in again from position X to Y in the second resolution. This point Y is relative to the display frame location in the display coordinate space. In the video coordinate space Y is at an offset from X. Hence, the region to zoom in is at an offset X+Y in the video coordinate space. The device 103 can be configured to perform a coordinate space translation to identify which region of the video space needs to be fetched. Further, the user zoom-in from position X to Y in the next second resolution level is represented as 403. The rectangle around Y in 403 identifies the position of Y in the next second resolution.

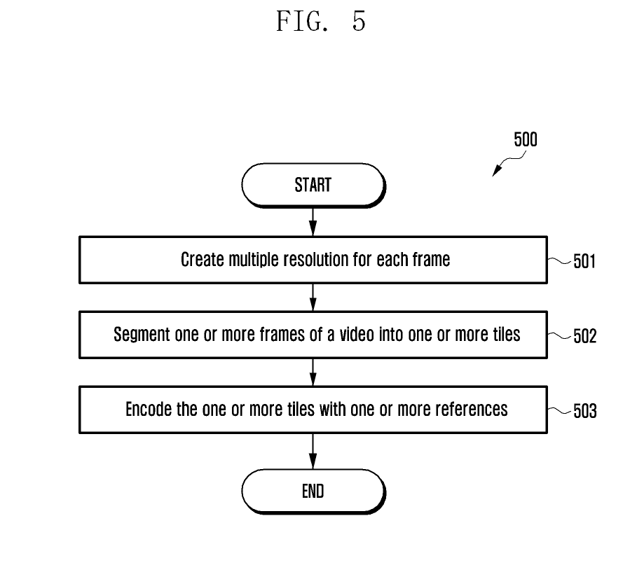

FIG. 5 is a flowchart describing a method of encoding a video according to an embodiment of the present disclosure.

Referring to FIG. 5, at operation 501, a method 500 includes creating multiple resolutions for each frame. Each video frame is represented at different resolutions levels. Representing a frame in multiple resolutions can allow users to zoom in a ROI at different resolution levels. At operation 502, the method 500 includes segmenting one or more frames of a video into one or more tiles. A tiler in a server can be configured to create one or more tiles in the video frame, and the frame corresponding to each resolution contains different tiles. At operation 503, the method 500 includes encoding the one or more tiles with one or more references. In an embodiment, each tile created by the automatic tiled video stream generator is associated with a reference. One or more references associated with one or more tiles associated with reference are sent to the device 102 in the descriptor file. The various operations illustrated in FIG. 5 may be performed in the order presented, in a different order or simultaneously. Further, in some various embodiments, some operations listed in FIG. 5 may be omitted.

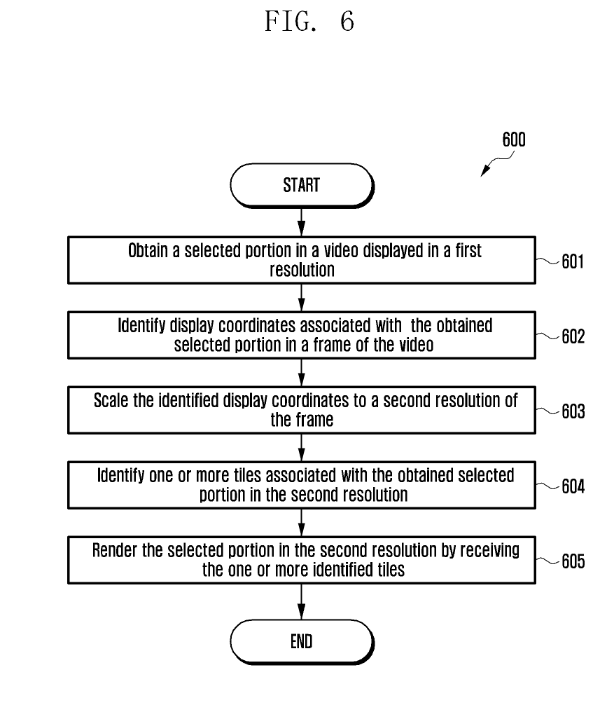

FIG. 6 is a flowchart describing a method of rendering a selected portion in second resolution according to an embodiment of the present disclosure.

Referring to FIG. 6, on receiving a video and associated descriptor file, the device 103 can be configured to render the video using a player. At operation 601, a method 600 includes obtaining a selected portion in a video displayed in a first resolution. The selected portion in a video is identified based on a user interaction with the video. The user interaction can include zoom, pan and change of the angle of view. The change of the angle of view can be determined based on detection of tilt associated with the user face. At operation 602, the method 600 includes identifying display coordinates associated selected portion in a frame of the video. The user interaction in the video displayed on the device 103 is associated with a display coordinates. The device 103 can be configured to identify display coordinates corresponding to the first resolution of the video frame. At operation 603, the method 600 includes scaling the identified display coordinates to a second resolution of the frame. The device 103 can be configured to translate the identified display coordinates to video coordinates in the second resolution of the video frame. The selected portion of video may be present at different positions in different resolutions of the video frame. At operation 604, the method 600 includes identifying one or more tiles associated with the obtained selected portion in the second resolution. The device 103 can be configured to identify one or more tile associated with selected portion. Each resolution of the video frame has a different tile configuration. The device 103 can be configured to identify one or more tiles corresponding to the selected portion in the second resolution. Each tile is associated with the reference. In an embodiment, the reference can be a URL or any other identifier to identify the tile associated with the selected portion. The device 103 can be configured to determine the reference associated with the identified tile from a descriptor file. The reference containing a video stream of the selected tile may be present in the HTTP server 101. At operation 605, the method 600 includes rendering the selected portion in the second resolution by receiving the one or more identified tiles. The player streams the reference (video stream) associated with the tile (associated with selected portion) on the device 103. From the descriptor file, the device 103 can be configured to identify the tile associated with the selected portion and the device 103 can be configured to send the request comprises the appropriate tile to retrieve from the HTTP server 101. The various operations illustrated in FIG. 6 may be performed in the order presented, in a different order or simultaneously. Further, in some various embodiments, some operations listed in FIG. 6 may be omitted.

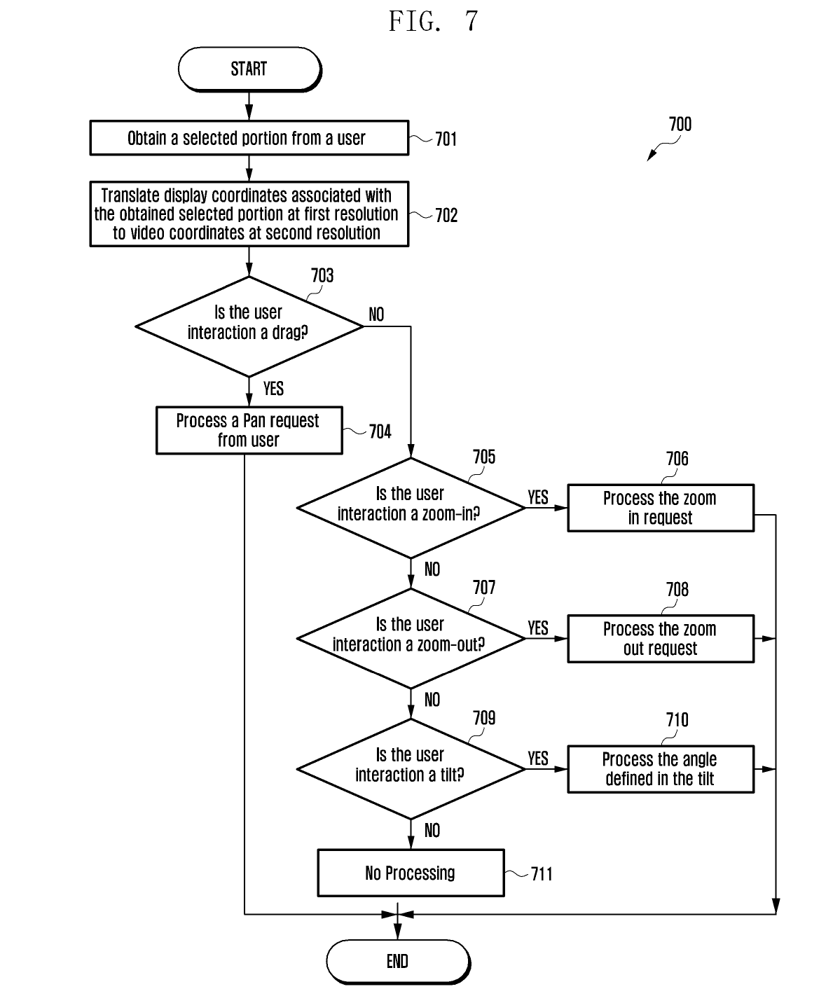

FIG. 7 is a flowchart describing a method of identifying user interaction with a video according to an embodiment of the present disclosure.

Referring to FIG. 7, on receiving a video and the descriptor file, the device 103 can be configured to render the video using a player. At operation 701, the method 700 includes obtaining a selected portion from a user. The user may interact by performing a zoom or pan on the display of the video. The selected portion can be identified based on the user interaction with the device 103. In an embodiment, a user tilt may be associated with the camera angle requested by the user. At operation 702, the method 700 includes translating display coordinates associated with the obtained selected portion at the first resolution to video coordinates at the second resolution. At operation 703, the method 700 includes checking if the user interaction is a drag. The device 103 can be configured to identify if the movement on the display while viewing the video is drag. At operation 704, if the user interaction is identified as a drag, the device 103 can be configured to processes a pan request. At operation 705, if the user interaction is not identified as a drag, the device 103 is configured to check if the user interaction is a zoom-in. At operation 706, if the user interaction is identified as a zoom-in, the device 103 can be configured to processes the zoom-in request. At operation 707, if the user interaction is not identified as a zoom-in, the device 103 can be configured to check if the user interaction is a zoom-out. At operation 708, if the user interaction is identified as a zoom-out, the device 103 can be configured to processes a zoom-out request. At operation 709, if the user interaction is not identified as a zoom-out, the device 103 can be configured to check if the user interaction is a tilt. At operation 710, if the user interaction is identified as tilt, the device 103 can be configured to processes the angle defined in tilt. At operation 711, if the user interaction is not identified at a tilt, no processing is performed. In this case, the device 103 will not associate the user interaction with any process.

In an embodiment, a time period is defined to the device to accept multiple user interactions before processing the user interaction (zoom in, zoom out and pan). For example, when user performs a zoom-in in the video continuously without taking his/her finger, then the device 103 can be configured to determine the time set to start processing the zoom-in.

The various operations illustrated in FIG. 7 may be performed in the order presented, in a different order or simultaneously. Further, in some various embodiments, some operations listed in FIG. 7 may be omitted.

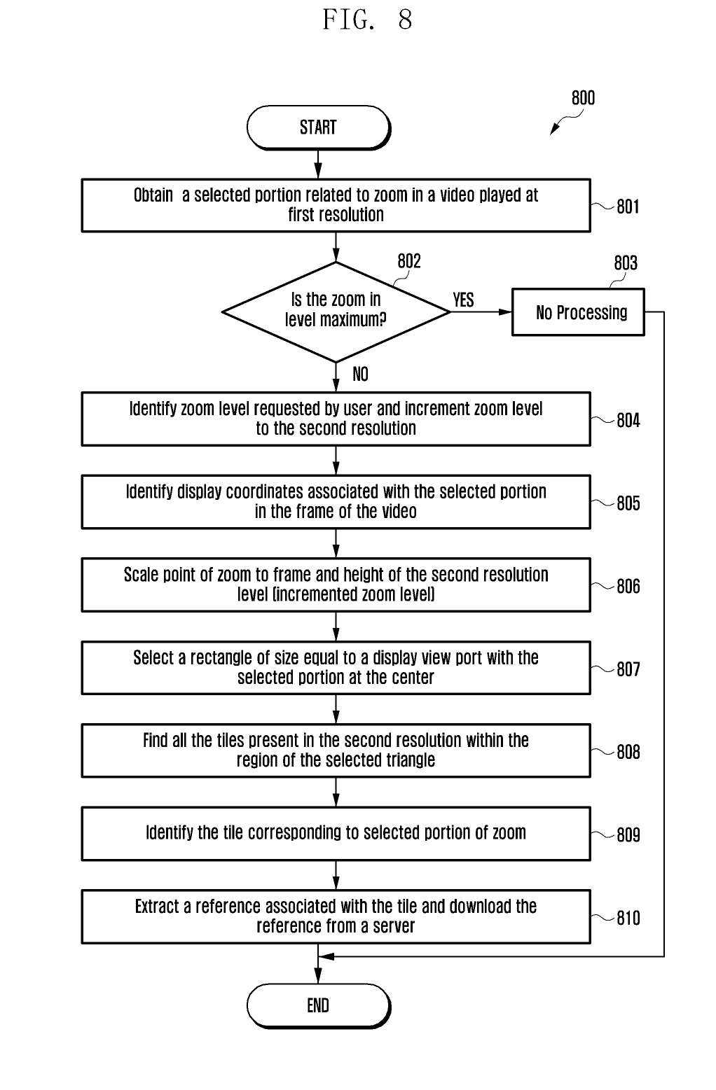

FIG. 8 is a flowchart describing a method of processing a zoom in interaction with a video at a device according to an embodiment of the present disclosure.

Referring to FIG. 8, at operation 801, a method 800 includes obtaining a selected portion related to zoom in a video played at a first resolution. The device 103 can be configured to identify the display coordinates associated with the obtained selected portion at the first resolution. At operation 802, the method includes checking if the zoom-in level is maximum. The device 103 can be configured to check if the video has already been zoomed in to a maximum resolution. At operation 803, if the zoomed-in video is already at a maximum level, no further zoom-in processing is possible. At operation 804, if the zoomed-in video is not at a maximum level the method 800 includes identifying zoom level requested by user and increment zoom level to the second resolution. The device 103 can be configured to identify the current zoom level (current resolution) of the frame in the video and increment the zoom level. At operation 805, the method 800 includes identifying display coordinates associated with the selected portion in the frame of the video. The display coordinates are identified using the thumbnail video. At operation 806, the method 800 includes scaling the point of zoom to the frame and height of the second resolution level (incremented zoom level). The device 103 can be configured to translate the identified display coordinates to video coordinates in the second resolution (corresponding to incremented zoom level). The selected portion of video may be present at different positions in different resolutions of the video frame. At operation 807, the method 800 includes selecting a rectangle of size equal to a display view port with the selected portion at the center. The rectangle around the selected portion identifies the position of the selected portion in the second resolution. At operation 808, the method 800 includes finding all the tiles present in the second resolution within the region of the selected rectangle. The device 103 can be configured to identify one or more tiles associated with selected portion in the second resolution with incremented zoom level. Each resolution of the video frame has a different tile configuration. The device 103 can be configured to identify all the tiles covering the selected portion at the second resolution.

At operation 809, the method 800 includes identifying the tile corresponding to the selected portion of zoom. The tile is identified from all the tiles present in the rectangle. The tile contains the selected portion identified by the display coordinates.

At operation 810, the method 800 includes extracting a reference associated with the selected tile, and downloading the reference from the HTTP server 101. Each tile is associated with the reference (for example: URL). The device 103 can be configured to determine the reference associated with the identified tile from the descriptor file. The reference containing a video stream of the selected tile may be present in the HTTP server 101. The selected portion (zoomed-in portion) is rendered in the second resolution by receiving the identified tile. The URL associated with the identified tile is streamed from the HTTP server 101. The player streams the reference (video stream) associated with the tile (associated with selected portion) on the device 103. In an embodiment, the device 103 can be configured to render the selected portion from the thumbnail video before rendering the selected portion at a higher resolution (second resolution). This allows the user to recognize that user interaction (zoom in) is being processed and the selected portion at higher resolution will be rendered.

The various operations illustrated in FIG. 8 may be performed in the order presented, in a different order or simultaneously. Further, in some various embodiments, some operations listed in FIG. 8 may be omitted.

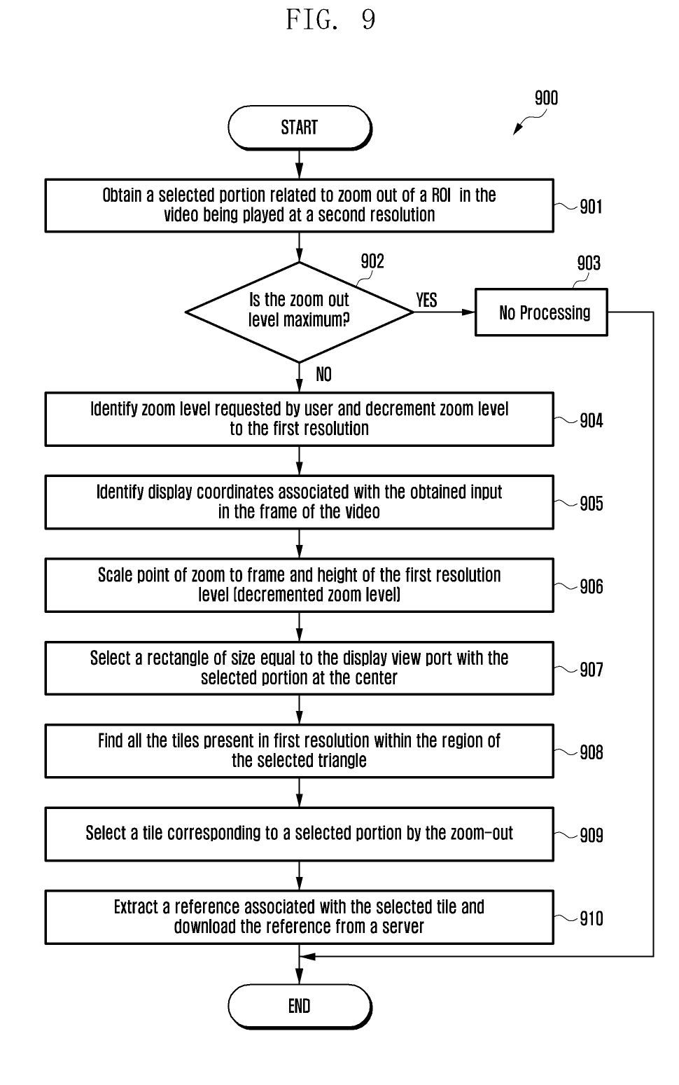

FIG. 9 is a flowchart describing a method of processing a zoom out interaction with a video at a device according to an embodiment of the present disclosure.

Referring to FIG. 9, at operation 901, a method 900 includes obtaining a selected portion related to zoom out a ROI in a video played at a second resolution. The device 103 can be configured to identify the display coordinates associated with the obtained selected portion at the second resolution. At operation 902, the method 900 includes checking if the zoom-out level is at a maximum. The device 103 can be configured to check if the video has already been zoomed out to a minimum resolution. At operation 903, if the method 900 identifies that the video is zoomed out and is already at a maximum level, no further zoom out processing is possible by the user.

At operation 904, the method 900 includes, if the zoom-out level is not maximum identifying a zoom level requested by a user and decrementing the zoom level to the first resolution. The device 103 can be configured to identify the current zoom level (current resolution) of the frame in the video and decrement the zoom level. At operation 905, the method 900 includes identifying display coordinates associated with the selected portion in the frame of the video. The display coordinates are identified using the thumbnail video.

At operation 906, the method 900 includes scaling the point of zoom to the frame and height of the first resolution level (decremented zoom level). The device 103 can be configured to translate the identified display coordinates to video coordinates in the first resolution (corresponding to decremented zoom level). The selected portion of video may be present at different positions in different resolutions of the video frame. At operation 907, the method 900 includes selecting a rectangle of size equal to a display view port with the selected portion at the center. The rectangle around the selected portion identifies the position of selected portion in the first resolution. At operation 908 the method 900 includes finding all the tiles present in the first resolution within the region of the selected rectangle. The device 103 can be configured to identify one or more tiles associated with selected portion in the second resolution with decremented zoom level. Each resolution of the video frame has a different tile configuration. The device 103 identifies all the tiles covering the selected portion at first resolution.

At operation 909, the method 900 includes identifying/selecting a tile corresponding to the selected portion by the zoom-out. The tile is identified from all the tiles present in the rectangle. The tile contains the selected portion identified by the display coordinates.

At operation 910, the method 900 includes extracting a reference associated with the selected tile, and downloading the reference from a server. The identified tile contains a reference associated with it. The device 103 can be configured to determine the reference associated with the identified tile from a descriptor file. The reference containing a video stream of the selected tile may be present in the HTTP server 101. The selected portion (zoomed out portion) is rendered in the first resolution by receiving the identified tile. The reference can be a URL which can be streamed from the HTTP server 101. The player streams the reference (video stream) associated with the tile (associated with selected portion) on the device 103.

In an embodiment, the device 103 can be configured to render the selected portion from the thumbnail video before rendering the selected portion at a lower resolution. This allows the user to recognize that user interaction is being processed and the selected portion at lower resolution will be rendered. The various operations illustrated in FIG. 9 may be performed in the order presented, in a different order or simultaneously. Further, in some various embodiments, some operations listed in FIG. 9 may be omitted.

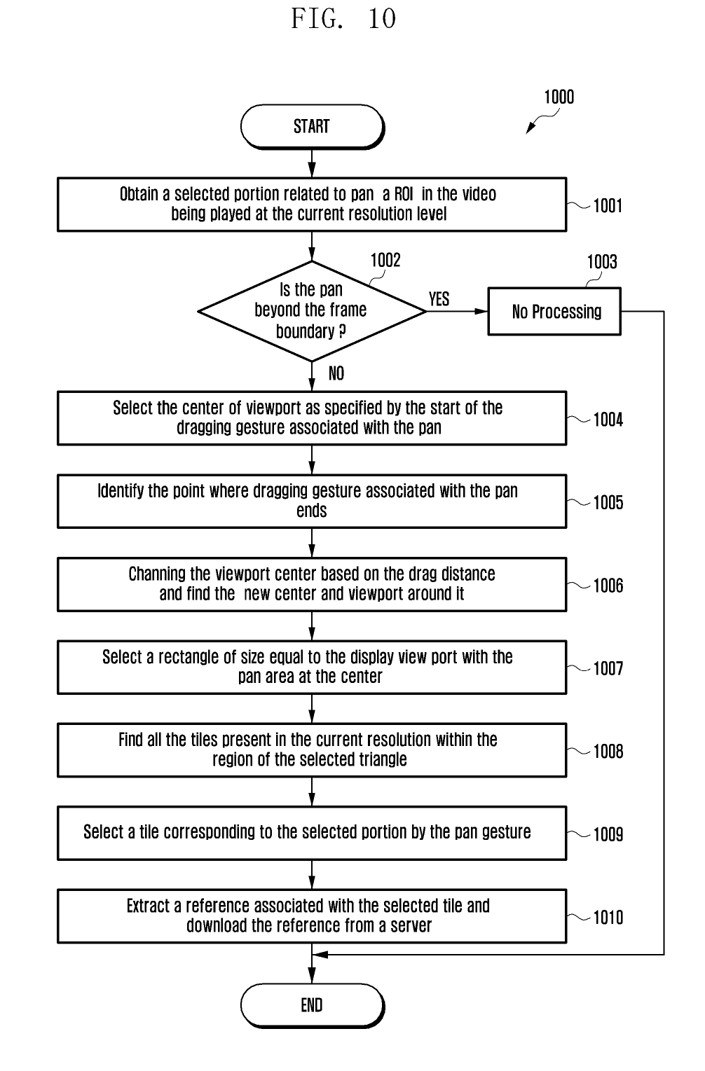

FIG. 10 is a flowchart describing a method of processing a pan interaction with a video at a device according to an embodiment of the present disclosure.

Referring to FIG. 10, at operation 1001, a method 1000 includes obtaining a selected portion related to pan a ROI in the video being played at the current resolution level. The device 103 can be configured to identify the display coordinates associated with the obtained selected portion at second resolution. At operation 1002, the method 1000 includes checking if the pan is beyond the frame boundary. The device 103 can be configured to check if the pan is beyond the frame boundary. At operation 1003, if the pan is beyond the frame boundary, then no pan processing is possible.

At operation 1004, the method 1000 includes if the pan is not beyond the frame boundary selecting the center of viewport as specified by the start of the dragging gesture associated with the pan (i.e., a pan zoom level requested by a user). The device 103 can be configured to identify the current zoom level (current resolution) of the frame in the video and identify display coordinates associated with the start of the dragging gesture. The display coordinates are identified using the thumbnail video.

At operation 1005, the method 1000 includes identifying the point where a dragging gesture associated with the pan ends. The device 103 can be configured to identify display coordinates associated with the ending of the dragging gesture. The display coordinates are identified using the thumbnail video.

At operation 1006, the method 1000 includes changing the viewport center based on the drag distance and finding the new center and viewport around it. The device 103 can be configured to offset the viewport center based on the display coordinates of the start and end point of the drag gesture.

At operation 1007, the method 1000 includes selecting a rectangle of size equal to the display view port with the selected portion at the center. The rectangle around the selected portion (panned area) is of same size as the display view port.

At operation 1008, the method 1000 includes finding all the tiles present in the current resolution within the region of the selected rectangle. The device 103 identifies all the tiles covering the panned area present in the rectangle. The device 103 is configured to identify one or more tiles associated with panned area in the current resolution. The tile contains the selected portion identified by the display coordinates.

At operation 1009, the method 1000 includes identifying/selecting a tile corresponding to panned area selected by the user. The tile is identified from all the tiles present in the rectangle. The tile contains the selected portion (panned area) identified by the display coordinates.

At operation 1010, the method 1000 includes extracting a reference associated with the selected tile, and downloading the reference from a server. The identified tile contains a reference associated with it. The device 103 can be configured to determine the reference associated with the identified tile from a descriptor file. The reference containing a video stream of the selected tile may be present in the HTTP server 101. The panned portion is rendered in the current resolution by receiving the identified tile. The reference can be a URL which can be streamed from the HTTP server 101. The player streams the reference (video stream) associated with the tile (associated with selected portion) on the device 103. The various operations illustrated in FIG. 10 may be performed in the order presented, in a different order or simultaneously. Further, in some various embodiments, some operations listed in FIG. 10 may be omitted.

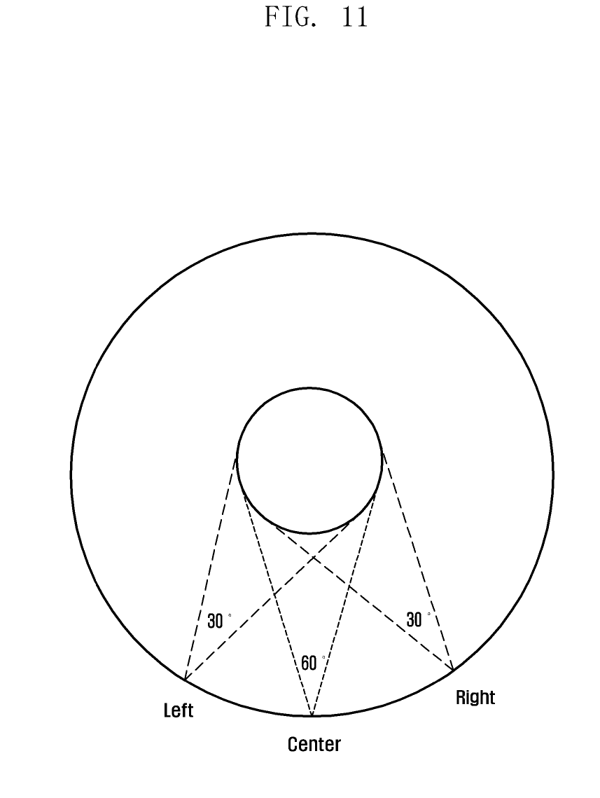

FIG. 11 is an example illustration of multi-view video from multiple individual cameras according to an embodiment of the present disclosure.

Referring to FIG. 11, three different cameras including a center camera, a right camera and a left camera capturing the same video from different angles are illustrated. Each camera records the video in a different angle (e.g., 30 degrees, 60 degrees, etc.). Hence multiple views of the frame (a scene) can be recorded using multiple cameras. The user of an electronic device can select the angle to view. For example, when viewing a sporting event, the user may select the left camera to view a specific portion in the frame, which is captured in detail by the left camera. After selecting the angle view, the user can interact with the video streamed. The user can zoom in, zoom out and pan a ROI and view the selected ROI at higher resolution. In an embodiment, the details of the multi-view camera angle are included in the descriptor file and send to the device 103 by the HTTP server 101. The extent by which the user shakes/jerks the device 103 is translated to a change in angle. The camera angle is calculated by converting linear displacement into angular motion using the below formula:

A=(360/(2*pi*r))*L

where L represents displacement, and r represents radius.

For Example, Considering unit circle of 1 cm, then max range for L is 0 to 2*pi=0 to 6.28. If L is 2 cm, view angle is 114, then appropriate view is picked from the MDF file.

In an embodiment, a gyroscopic gesture from a user may be translated to a view angle of camera.

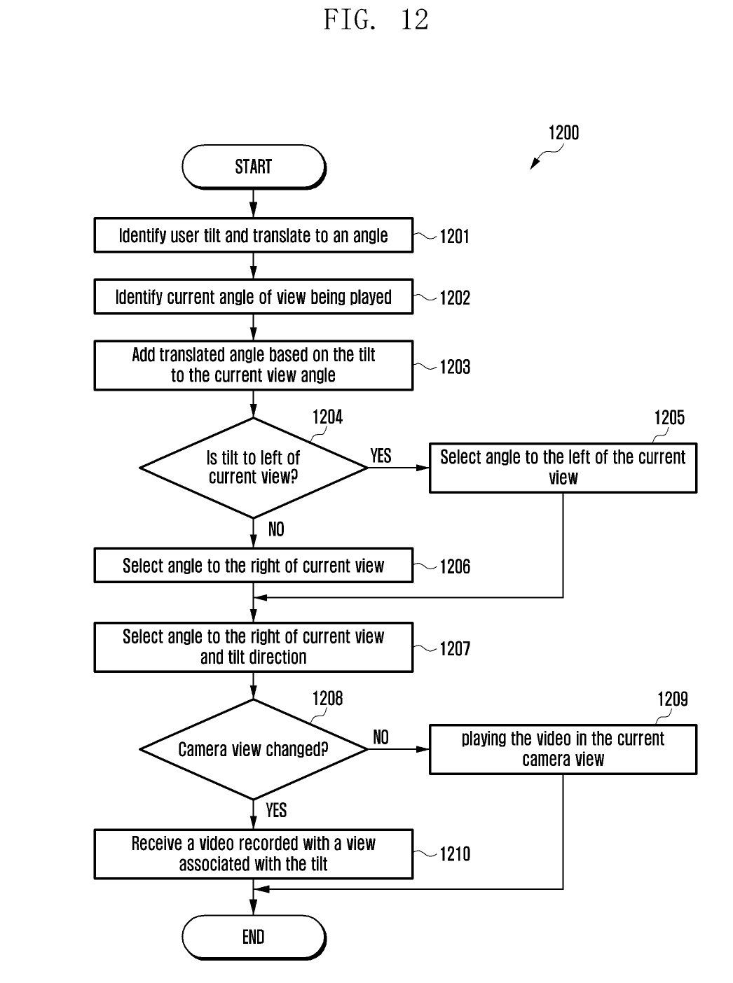

FIG. 12 is a flowchart describing a method of processing change in camera view at a device according to an embodiment of the present disclosure.

Referring to FIG. 12, at operation 1201, a method 1200 includes identifying user tilt and convert/translate to an angle. A gyroscopic gesture from the user may be translated to an angle. The extent by which the user shakes or jerks the device can be translated to a change angle. At operation 1202, the method 1200 includes identifying the current angle of view being played. The video streamed to the user is generally in a default view which can be from a center camera. The device 103 can be configured to identify the current angle view of the video being played on the device on detecting a tilt from the user. In an embodiment, a user gesture is detected and accordingly the camera angle is determined. The angles associated with the multi-view camera are sent along with the descriptor file to the device 103.

At operation 1203, the method 1200 includes adding translated angle based on the tilt to the current view angle of camera. The translated angle is added to the current angle of the camera view of the video to identify if the tilt is to the right or left of the current view angle of the video.

At operation 1204, the method 1200 includes checking if the tilt is towards left of the current view. Based on the gesture in the previous operation, the device 103 can be configured to determine if the tilt is towards left of the current view or right of the current view.

At operation 1205, the method 1200 includes selecting an angle to the left of the current view, if the tilt is towards left of the current view. At operation 1206, the method 1200 includes selecting an angle to the right of the current view, if the tilt is not towards left of the current view. At operation 1207, the method 1200 includes finding/selecting a camera view closest to the calculated angle and tilt direction. The device 103 can be configured to find a camera view based on the calculated viewing angle (translated angle+current angle view).

At operation 1208, the method 1200 includes checking if the camera view is changed. Based on the calculated viewing angle, the device 103 can determine if the current view needs to be changed.

At operation 1209, the method 1200 includes playing the video in the current camera view, if the camera view has not changed. If the calculated angle is within the range of view of the current camera view, the user can continue watching the video in the current camera view.

At operation 1210, the method 1200 includes receiving a video recorded with the view associated with the tilt, if the camera view has changed. If the calculated viewing angle is out of the range of the current camera, the device 103 can be configured to identify which camera angle view captured the tilt of the user. The device 103 can identify the camera angle view from the angle list stored in the descriptor file. Based on the calculated viewing angle, the camera angle view can be chosen and streamed on the device 103.

Consider an example when a sporting event like football are being viewed on the device 103. The user may want to view the video from a different angle view. On detecting a user tilt and converting to it to angle, the camera view is chosen. If the camera view is changed, the device can receive a video recorded with the camera view associated with the tilt. The user can interact with the rendered video. The various operations illustrated in FIG. 12 may be performed in the order presented, in a different order or simultaneously. Further, in some various embodiments, some operations listed in FIG. 12 may be omitted.

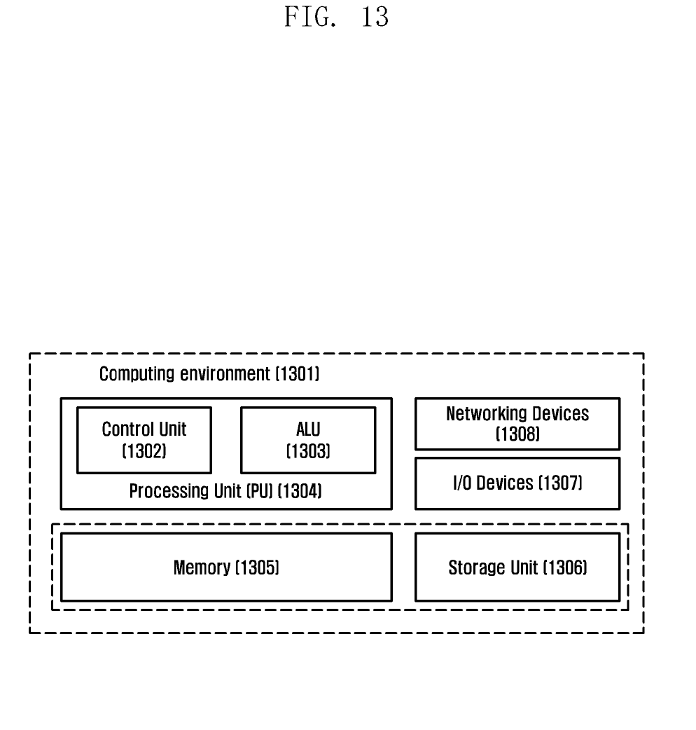

FIG. 13 illustrates a computing environment according to an embodiment of the present disclosure.

Referring to FIG. 13, a computing environment 1301 comprises at least one processing unit 1304 that is equipped with a control unit 1302 and an Arithmetic Logic Unit (ALU) 1303, a memory 1305, a storage unit 1306, plurality of networking devices 1308 and a plurality of Input/Output (I/O) devices 1307. The processing unit 1304 is responsible for processing the instructions of the algorithm. The processing unit 1304 receives commands from the control unit in order to perform its processing. Further, any logical and arithmetic operations involved in the execution of the instructions are computed with the help of the ALU 1303.

The overall computing environment 1301 can be composed of multiple homogeneous and/or heterogeneous cores, multiple CPUs of different kinds, special media and other accelerators. The processing unit 1304 is responsible for processing the instructions of the algorithm. Further, the plurality of processing units 1304 may be located on a single chip or over multiple chips. The algorithm comprising of instructions and codes required for the implementation are stored in either the memory unit 1305 or the storage 1306 or both. At the time of execution, the instructions may be fetched from the corresponding memory 1305 and/or storage 1306, and executed by the processing unit 1304.

In case of any hardware implementations various networking devices 1308 or external I/O devices 1307 may be connected to the computing environment 1301 to support the implementation through the networking unit(s) 1308 and the I/O device(s) 1307.

The various embodiments disclosed herein can be implemented through at least one software program running on at least one hardware device and performing network management functions to control the elements. The elements shown in FIGS. 1, 2, and 13 include blocks which can be at least one of a hardware device, or a combination of hardware device and software module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for rendering a selected portion in a video displayed in an electronic device, the method comprising:
obtaining, via an electronic device, the selected portion in the video, wherein the video is played in a first resolution;
identifying at least one tile associated with the obtained selected portion in a second resolution; and
rendering the selected portion in the second resolution by receiving the at least one identified tile.

2. The method as in claim 1, wherein the method further comprises:
identifying display coordinates associated with the obtained selected portion in at least one frame of the video; and
scaling the identified display coordinates to the second resolution of the at least one frame.

3. The method as in claim 1, wherein the method further comprises obtaining the at least one identified tile before rendering the selected portion.

4. The method as in claim 1, wherein the at least one tile comprises audio associated with at least one frame of the video.

5. The method as in claim 1, wherein the method further comprises rendering the selected portion in the first resolution from a thumbnail video before rendering the selected portion in the second resolution.

6. The method as in claim 5, wherein the method further comprises rendering the selected portion with audio received from the thumbnail video.

7. The method as in claim 1, wherein the method further comprises identifying at least one reference corresponding to the at least one tile.

8. The method as in claim 7, wherein the method further comprises:
sharing the at least one reference of the selected portion to a target device by the electronic device; and
rendering the selected portion in the target device.

9. The method as in claim 1, wherein the method further comprises:
tracking the selected portion in at least one future frame of the video;
identifying at least one tile associated with the tracked selected portion in the at least one future frame; and
obtaining the at least one identified tile associated with the tracked selected portion in the video.

10. A method for encoding at least one tile in a video, the method comprising:
segmenting, via a server, at least one frame of the video into at least one tile, wherein the at least one frame is associated with at least one resolution;
encoding the at least one tile; and
assigning a reference to the encoded tile.

11. The method as in claim 10, wherein the method further comprises:
creating a file with information associated with the encoded at least one tile, wherein the file is encrypted; and
sending the created file with the video to an electronic device.

12. The method as in claim 10, wherein the encoding comprises associating audio with the at least one tile.

13. The method as in claim 10, wherein the method further comprises sending a thumbnail stream along with the video to an electronic device, as a thumbnail video, wherein a resolution of the thumbnail video is less compared to the first resolution and the thumbnail video is rendered at lower frame rate, and wherein the thumbnail video comprises audio.

14. An electronic device for rendering a selected portion in a video, the electronic device comprising:
an integrated circuit further comprising at least one processor; and
at least one memory storing a computer program code;
wherein, when executed, the computer program code causes the at least one processor of the electronic device to:
obtain the selected portion in the video, wherein the video is played in a first resolution;
identify at least one tile associated with the obtained selected portion in a second resolution; and
render the selected portion in the second resolution by receiving the at least one identified tile.

15. The electronic device as in claim 14, wherein the electronic device is further configured to:
identify display coordinates associated with the obtained selected portion in at least one frame of the video; and
scale the identified display coordinates to the second resolution of the at least one frame.

16. The electronic device as in claim 14, wherein the electronic device is further configured to obtain the at least one identified tile before rendering the selected portion.

17. The electronic device as in claim 14, wherein the at least one tile comprises audio associated with at least one frame of the video.

18. The electronic device as in claim 14, wherein the electronic device is further configured to render the selected portion in the first resolution from a thumbnail video before rendering the selected portion in the second resolution.

19. The electronic device as in claim 18, wherein the electronic device is further configured to render the selected portion with audio received from the thumbnail video.

20. The electronic device as in claim 14, wherein the electronic device is further configured to identify at least one reference corresponding to the at least one tile.

21. The electronic device as in claim 20, wherein the electronic device is further configured to:
share the at least one reference of the selected portion to a target device; and
render the selected portion in the target device.

22. The electronic device as in claim 14, wherein the electronic device is further configured to:
track the selected portion in at least one future frame of the video;
identify at least one tile associated with the tracked selected portion in the at least one future frame; and
obtain the at least one identified tile associated with the tracked selected portion in the video.

23. The electronic device as in claim 14, wherein the selected portion in the video is identified based on a user interaction with the video, the user interaction being any one of a zoom operation, a pan operation and a change of an angle of view determined based on a detection of a tilt associated with a user's face.
